(19) United States
(12) Patent Application Publication
(10) Pub. No.: US 2023/0177517 A1
(43) Pub. Date: Jun. 8, 2023

(54) KNOWLEDGE MANAGEMENT SYSTEM FOR ACCESSING PLAYBOOKS AND ASSOCIATED APPLICATIONS AND METHOD THEREOF

(71) Applicant: RAKUTEN MOBILE, INC., Tokyo (JP)

(72) Inventors: Anshul Jyotinbhai Bhatt, Tokyo (JP); Sneha Barman, Singapore (SG); Vikas Nirala, Tokyo (JP); Keerthi Korakolla, Tokyo (JP); Rina Takamatsu, Tokyo (JP); Vasudev Tiwari, Indore (IN); Amber Jain, Indore (IN)

(73) Assignee: RAKUTEN MOBILE, INC., Tokyo (JP)

(21) Appl. No.: 17/457,287

(22) Filed: Dec. 2, 2021

(51) Int. Cl. G06Q 30/00; G06F 9/54; G06N 5/02

(52) U.S. Cl. CPC G06Q 30/016; G06F 9/541; G06N 5/02

(57) ABSTRACT

A method of operating a knowledge management system includes receiving information associated with a customer input; determining a playbook, from among a plurality of playbooks, based on the information associated with the customer input; executing the playbook based on determining the playbook; obtaining, via a plurality of application programming interfaces (APIs) integrated with the playbook, information associated with the issue, based on executing the playbook; providing the information associated with the issue, based on obtaining the information associated with the issue via the plurality of APIs; and executing, via the plurality of APIs integrated with the playbook, functions on one or more applications for resolving the issue.

### BACKGROUND

### 1. Technical Field

The present disclosure relates to a knowledge management system, and in particular, relates to a knowledge management system providing access to playbooks that include manual steps to be performed by a user and automated steps performed on external applications through Application Programming Interfaces (APIs).

### 2. Description of Related Art

Knowledge management systems in the related art are one dimensional and static. These knowledge management systems are capable of inputting pictures and text, but are unable to handle other forms of content.

Additionally, knowledge management systems in the related art are rigid and restrictive. The systems are constrained by specific types of content and are unable to operate with interactive content. Further, these knowledge management systems cannot generate and manage content that interfaces with outside applications to autonomously perform tasks.

### SUMMARY

An aspect of the disclose provides a method including: receiving, by a device and from a customer relationship management (CRM) application, information associated with a customer input; determining, by the device, a playbook, from among a plurality of playbooks, based on the information associated with the customer input, wherein the playbook is a set of predefined steps to perform to resolve an issue; executing, by the device, the playbook based on determining the playbook; obtaining, by the device and via a plurality of application programming interfaces (APIs) integrated with the playbook, information associated with the issue, based on executing the playbook; providing, by the device and to the CRM application, the information associated with the issue, based on obtaining the information associated with the issue via the plurality of APIs; and executing, by the device and via the plurality of APIs integrated with the playbook, functions on one or more applications for resolving the issue.

The plurality of APIs may include a ticket API, a CRM API, and an API corresponding to the one or more applications.

The method may further include determining, by the device, a plurality of similarity scores between the plurality of playbooks and the information associated with the customer input; and determining, by the device, a highest similarity score from among the plurality of similarity scores. The determining, by the device, the playbook may include determining, by the device, the playbook based on a playbook having the highest similarity score.

The method may further include determining, by the device, a plurality of similarity scores between the plurality of playbooks and the information associated with the customer input; and determining, by the device, a similarity score from among the plurality of similarity scores that satisfies a threshold. The determining, by the device, the playbook may include determining, by the device, the playbook based on a playbook having the similarity score that satisfies the threshold.

The set of predefined steps may include a set of automated steps and a set of manual steps. The obtaining, by the device and via the plurality of APIs, the information associated with the issue may include obtaining, by the device and via the plurality of APIs, the information associated with the issue based on one or more of the automated steps.

The method may further include receiving, by the device and from the CRM application, information that is responsive to a manual step of the playbook; and obtaining, by the device and via an API of the plurality of APIs, additional information associated with the issue based on the information that is responsive to the manual step.

The playbook may include customizable and pre-configurable information associated with the set of predefined steps, expected results, and a set of additional steps.

Another aspect of the disclosure provides a device that may include a memory configured to store instructions; and a processor configured to execute the instructions to: receive, from a customer relationship management (CRM) application, information associated with a customer input; determine a playbook, from among a plurality of playbooks, based on the information associated with the customer input, wherein the playbook is a set of predefined steps to perform to resolve an issue; execute the playbook based on determining the playbook; obtain, via a plurality of application programming interfaces (APIs) integrated with the playbook, information associated with the issue, based on executing the playbook; provide, to the CRM application, the information associated with the issue, based on obtaining the information associated with the issue via the plurality of APIs; and execute, via the plurality of APIs integrated with the playbook, functions on one or more applications for resolving the issue.

The plurality of APIs may include a ticket API, a CRM API, and an API corresponding to the one or more applications.

The processor may be further configured to: determine a plurality of similarity scores between the plurality of playbooks and the information associated with the customer input; and determine a highest similarity score from among the plurality of similarity scores. The playbook may be determined based on a playbook having the highest similarity score.

The processor may be further configured to: determine a plurality of similarity scores between the plurality of playbooks and the information associated with the customer input; and determine a similarity score from among the plurality of similarity scores that satisfies a threshold. The playbook may be determined based on a playbook having the similarity score that satisfies the threshold.

The set of predefined steps may include a set of automated steps and a set of manual steps. The processor may be further configured to obtain, via the plurality of APIs, the information associated with the issue based on one or more of the automated steps.

The processor may be further configured to: receive information that is responsive to a manual step of the playbook; and obtain, via an API of the plurality of APIs, additional information associated with the issue based on the information that is responsive to the manual step.

The playbook may include customizable and pre-configurable information associated with the set of predefined steps, expected results, and a set of additional steps.

Yet another aspect of the disclosure provides a non-transitory computer-readable medium storing instructions, the instructions may include one or more instructions that, when executed by one or more processors of a device, cause the one or more processors to: receive, from a customer relationship management (CRM) application, information associated with a customer input; determine a playbook, from among a plurality of playbooks, based on the information associated with the customer input, wherein the playbook is a set of predefined steps to perform to resolve an issue; execute the playbook based on determining the playbook; obtain, via a plurality of application programming interfaces (APIs) integrated with the playbook, information associated with the issue, based on executing the playbook; provide, to the CRM application, the information associated with the issue, based on obtaining the information associated with the issue via the plurality of APIs; and execute, via the plurality of APIs integrated with the playbook, functions on one or more applications for resolving the issue.

The plurality of APIs may include a ticket API, a CRM API, and an API corresponding to the one or more applications.

The instructions may further cause the one or more processors to: determine a plurality of similarity scores between the plurality of playbooks and the information associated with the customer input; and determine a highest similarity score from among the plurality of similarity scores. The playbook may be determined based on a playbook having the highest similarity score.

The instructions may further cause the one or more processors to: determine a plurality of similarity scores between the plurality of playbooks and the information associated with the customer input; and determine a similarity score from among the plurality of similarity scores that satisfies a threshold. The playbook may be determined based on a playbook having the similarity score that satisfies the threshold.

The set of predefined steps may include a set of automated steps and a set of manual steps. The instructions may further cause the one or more processors to obtain, via the plurality of APIs, the information associated with the issue based on one or more of the automated steps.

The instructions may further cause the one or more processors to: receive information that is responsive to a manual step of the playbook; and obtain, via an API of the plurality of APIs, additional information associated with the issue based on the information that is responsive to the manual step.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is diagram of a knowledge management system according to an embodiment;

FIG. 2 is a diagram of an example environment in which systems and/or methods, described herein, may be implemented;

FIG. 3 is a diagram of example components of a device for interacting with the knowledge management system according to an embodiment;

FIG. 4 is a diagram of an example process 400 for addressing a customer issue using a knowledge management system.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise.

A knowledge management system according to the present disclosure provides access to stored playbooks and articles. The playbooks may include automated steps which utilize Application Programming Interfaces (APIs) to seamlessly access and perform functions on applications. The playbooks may also include manual steps that do not require any APIs.

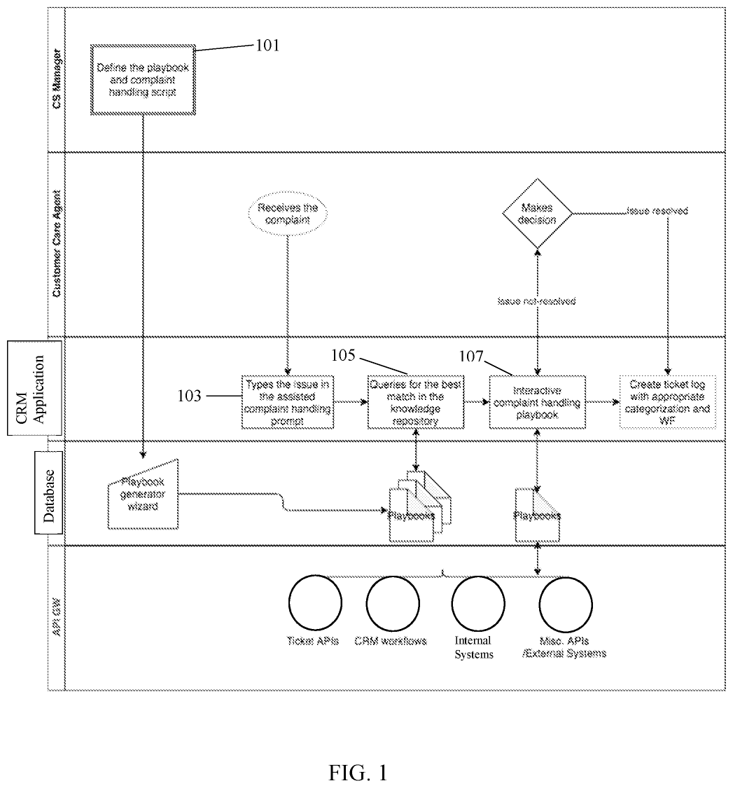

FIG. 1 is a flowchart of an overview of a method of addressing a customer input using the knowledge management system according to an embodiment. In the embodiment of FIG. 1, the customer input is described as a complaint, however the customer input is not limited to complaints and may be any request or inquiry that may be addressed by an agent utilizing the knowledge management system. For the sake of explaining the method, in the below description, the complaint received by the customer care agent will be described as customer complaint of a cellular phone not properly connecting to a cellular network. Accordingly to other embodiments, the input (e.g. complaint) may be provided by an employee, a vendor, or the like.

Referring to FIG. 1, at operation 101, a playbook for handling a complaint may be created. The playbook may be created using a playbook generator wizard that produces an executable workflow including a series of automated and/or manual steps to be executed by a customer care agent. The playbook may provide a set of predefined steps to resolve an issue.

The automated steps may be steps that utilize APIs to communicate with external applications. The APIs may be used to obtain information from the external applications, provide information to the external applications, and/or to control the external applications. For example, an automated step may utilize and API to access an application managing a cellular network. Through the API, the automated step may request the status of a specific phone number or request that the cellular management program may perform a debugging operation for the specified cellular number. The automated step may include multiple autonomous operations, such as sending information to the external application through the API, receiving information from the external application through the API, storing the received information, and outputting the received information to another external application through a second API.

The manual steps may be steps that do not use APIs. For example, a manual step may ask the customer care agent to input a phone number of the customer or may directed the customer care agent to ask the customer to restart their phone.

The playbook generator wizard may save a completed playbook to one or more databases for access by a customer relationship management (CRM) application. Keywords describing the function of the playbook may be associated with the playbook for use when searching the one or more databases.

At operation 103, a customer care agent may input the complaint received from a customer into a CRM application. For example, the customer care agent may type in a natural language input describing the complaint. Regarding the complain of the cellular phone not connecting, the customer care agent may input “cellular phone not connecting to network.”

At operation 105, the CRM application may search one or more databases for playbooks and/or articles that best match the customer care agent input. The articles may only provide information such as text and figures, while the playbooks may provide an interactive workflow. According to an embodiment, the one or more databases may include multiple databases corresponding to different departments of a company. In an embodiment including databases corresponding to different departments of a company, a single CRM application can be used to access information such as playbooks corresponding to any department.

For example, in response to the above input, the CRM application may search the database for a category related to cellular phones and search the category for playbooks most relevant to cellular connectivity. The CRM application may then access the best match for use by the customer care agent.

At operating 107, the customer care agent may interactively handle the complaint by executing the playbook determined to best match the information input by the customer care agent. The customer care agent may progress through the automated and/or manual steps of the executable workflow of the playbook to resolve the complaint.

By executing an automated steps, the customer care agent may access information spread out over one or more external applications using only the CRM application. Further, by executing an automated steps, the customer care agent is able to control the one or more external applications to perform functions using only the CRM application. According to some embodiments, the automated steps may include ticket APIs, CRM workflow APIs, APIs to internal systems, and/or APIs to external systems. The APIs of the automated steps are not limited to the preceding list and may include APIs for any application that may assist in addressing a customer input.

For example, a first step of an executable workflow of a playbook for resolving cellular connectivity issues may begin with a manual step requesting the customer care agent to request the phone number of the customer and then input the phone number into the CRM application.

Upon completion of the first step, a second step may be executed. The second step of the executable workflow may be an automated step for determining a status of an account associated with the phone number from an application managing the cellular network. Accordingly, the second step may autonomously send the phone number to the application managing the cellular network through an API along with instruction to check the status the of account associated with the phone number. The second step may also autonomously receive information pertaining to the status, store the information, and display the information in a format readable by a user.

A third step may be selected and executed based on the information provided by the second step. For example, in a case where the application managing the cellular network returns information indicating that the account associated with the phone number is not active, an automated step which directs the application managing the cellular network, through an API, to activate the account associated with the phone number may be selected and executed. In a case where the application managing the cellular network returns information indicating that the account associated with the phone number is active, an automated step which directs the application managing the cellular network, through an API, to send a reset signal to a phone associated with the phone number may be selected and executed.

The customer care agent may progress through the workflow of the playbook using the CRM application until the issue is resolved. Once the issue is resolved, the customer care agent may input that the issue has been resolved into the CRM program. In response to the input indicating the issue has been resolved, the CRM program may close the playbook and create a ticket log with appropriate categorization and workflow.

In this way, some implementations herein provide a knowledge management system that produces more efficient issue resolution through a single application that can access a variety of playbooks having integrated APIs. By providing the functionality of multiple application in a single application through APIs, an amount of clicks, and therefore an amount of time, to resolve an issue can be reduced. Further, the knowledge management system may provide a single system for efficiently generating, storing, and accessing a variety of playbooks for quick access by any user of the system.

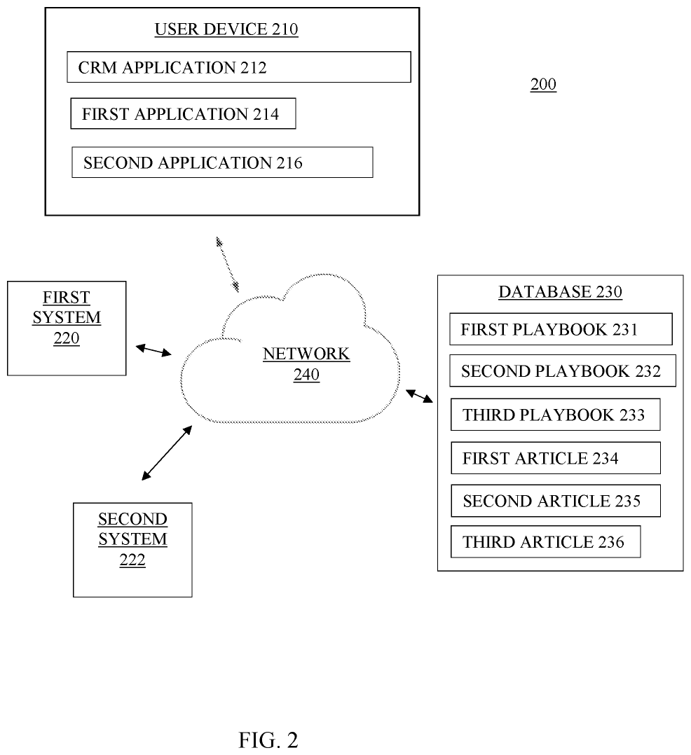

FIG. 2 is a diagram of an example environment 200 in which systems and/or methods, described herein, may be implemented. As shown in FIG. 2, environment 200 may include a user device 210, a first system 220, a second system 222, a database 230, and a network 240. Devices of environment 200 may interconnect via wired connections, wireless connections, or a combination of wired and wireless connections.

User device 210 may include one or more devices capable of receiving, generating, storing, processing, and/or providing information associated with the first system 220, the second system 222, and the database 230. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some embodiments, user device 210 may receive information from and/or transmit information to the first system 220, the second system 222, and the database 230.

The user device may include an CRM application 212 which receives information input by a user and outputs information to the user. The CRM application 212 may communicate with a first application 214 and a second application 216 on the user device 210 through respective APIs. The first application 214 and the second application 216 may communicate with a first system 220 and a second system 222 over the network 240. The CRM application may communicate with the database 230 through the network 240.

The first system 220 and the second system 222 may be internal system accessible through a local portion of the network 240 or external systems that are accessible over the network 240. The first system 220 and/or the second system 222 may be controlled by the first application 214 and/or the second application 216. The environment is not limited to two systems and may include more or less systems.

The database 230 may be connected to the network 240 and may include a first playbook 231, a second playbook 232, a third playbook 233, a first article 234, a second article 235, and a third article 236. The playbooks and articles may be indexed for efficient searching. Accordingly to some embodiments, the database 230 may include multiple databases. According to some embodiments, the database may be stored on the user device 210.

Network 240 may include one or more wired and/or wireless networks. For example, network 240 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

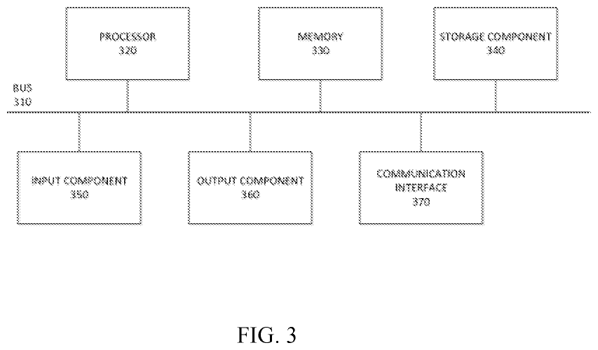

FIG. 3 is a diagram of example components of a device 300 for performing the method 100 according to an embodiment. The device 300 may correspond a single device that performs the method 100 or one of multiple devices that perform the method 100. The device 300 may include or be implemented as the user device 210 illustrated in FIG. 2. As shown in FIG. 3, the device 300 may include a bus 310, a processor 320 (or at least one processor), a memory 330 (or at least one memory), a storage component 340, an input component 350, an output component 360, and a communication interface 370.

The bus 310 may include a component that permits communication among the components of the device 300. That is, the bus 310 is a communication system or subsystem that permits the transfer of data and information between the components of the device 300.

The processor 320 may be implemented in hardware, firmware, or a combination of hardware and software. The processor 320 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 320 includes one or more processors capable of being programmed to perform a function.

The memory 330 stores information and/or instructions for use by the processor 320. The memory 330 may include at least one of a random access memory (RAM), a read only memory (ROM), and/or another type of dynamic or static storage device (e.g., a flash memory, a magnetic memory, and/or an optical memory) for storing information and/or instructions.

The storage component 340 may store information and/or software related to the operation and use of the device 300. For example, the storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 350 may include a component that permits the device 300 to receive information, such as via user input (e.g., a touch screen display, a keyboard, a keypad, a mouse, a button, a switch, and/or a microphone). Additionally, or alternatively, the input component 350 may include a sensor for sensing information (e.g., a global positioning system (GPS) component, an accelerometer, a gyroscope, and/or an actuator). The output component 360 may include a component that provides output information from the device 300 (e.g., a display, a speaker, one or more light-emitting diodes (LEDs), an interface for connecting to an external display or speaker, etc.).

The communication interface 370 may include a transceiver-like component (e.g., a transceiver and/or a separate receiver and transmitter) that enables the device 300 to communicate with other devices, such as via a wired connection, a wireless connection, or a combination of wired and wireless connections. The communication interface 370 may permit the device 300 to receive information from another device and/or provide information to another device. For example, the communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

The device 300 may perform one or more processes described herein. The device 300 may perform these processes via the processor 320 executing software instructions stored in a non-transitory computer-readable medium, such as the memory 330 and/or the storage component 340. A computer-readable medium is defined herein as a non-transitory memory device. A memory device includes memory space within a single physical storage device or memory space spread across multiple physical storage devices.

Software instructions may be read into the memory 330 and/or the storage component 340 from another computer-readable medium or from another device via the communication interface 370. When executed, software instructions stored in the memory 330 and/or the storage component 340 may cause the processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, the device 300 may include additional components, fewer components, different components, or differently arranged components than those shown in FIG. 3. Additionally, or alternatively, a set of components (e.g., one or more components) of the device 300 may perform one or more functions described as being performed by another set of components of device 300.

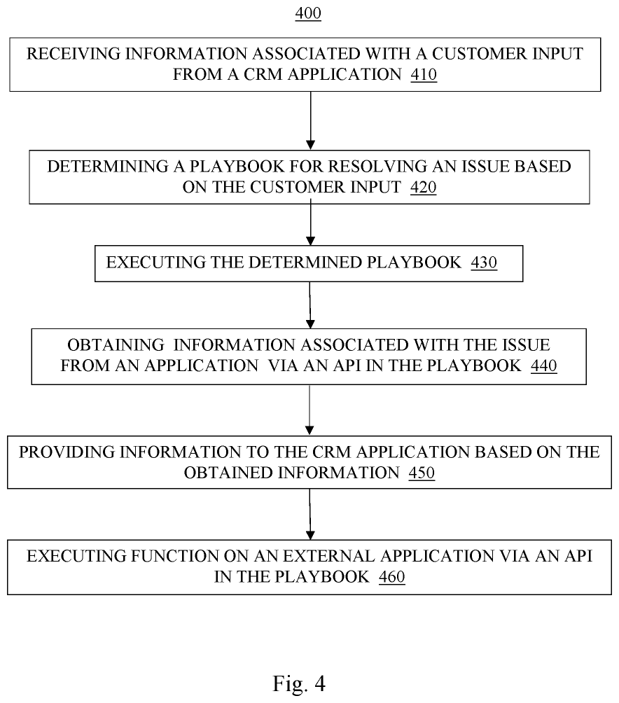

FIG. 4 is a diagram of an example process 400 of addressing a customer issue using a knowledge management system according to an embodiment. The operation may be performed on device 300 of FIG. 3, user device 210 of FIG. 2, or any other suitable device or combination of devices. The following description will reference user device 210 for the sake of explanation, but is not limited thereto.

In operation 410, information associated with a the customer input may be received through a CRM application of the user device 210. The information may be input into the CRM application by a user operating the device 210 through a user interface. For example, the user of the device 210 may receive an inquiry regarding an issue and may input information related to the issue into the CRM application.

In operation 420, the device 210 may select a playbook for resolving the issue provided in the inquiry. For example, the device 210 may search one or more databases storing multiple playbooks for a playbook having a best match to the information associated with the inquiry.

According to an embodiment, the user device 210 may determine a plurality of similarity scores between the multiple playbooks stored in the one or more databases and the information associated with the customer input. A playbook with the highest probability score may be determined as the playbook for resolving the issue provided in the customer input.

According to an embodiment, the user device 210 may determine a plurality of similarity scores between the multiple playbooks stored in the one or more databases and the information associated with the customer input. A playbook having a similarity score above a preset threshold may be determined as the playbook for resolving the issue provided in the customer input.

According to other embodiments, the playbook may be selected using other methods known in the art for finding a best match between character strings.

According to some embodiments, the one or more databases may include articles for resolving issues as well as the playbooks. The articles may be searched in conjunction with the playbooks, and the best match among the combination of the articles and playbooks may be used for resolving the issue provided in the customer input.

In operation 430, the user device may execute the determined playbook for resolving the issue provided in the customer input. The playbook may include a set of predefined steps to perform to resolve the issue. The predefined steps may include a set of automated steps and a set of manual steps.

The automated steps may utilize APIs for communicating with and performing functions on applications external to the CRM application. For example, by selecting an automated step, a preset routine in the automated step may autonomously perform one or more operations that communicate with an external application to receive information from the application, provide information to the external application, and/or control the external application to perform a function.

The manual steps may direct the user of the device 210 to perform steps. For example, a manual step may instruct the user to request information from the customer and then input the requested information into the CRM application. Other manual steps may instruct the user to instruct the customer to perform a step that may help resolve the issue.

In operation 440, information associated with the issue may be obtained from one or more applications external to the CRM application through one or more APIs interfacing the CRM application and the one or more external applications. By executing an autonomous step, the CRM application is able to communicate with the external application to obtain information. For example, the CRM application may request, from the external application through the API, a status of or data related to an account associated with the customer.

According to some embodiments, the API may be a ticket API, a CRM API, an API corresponding to one or more internal systems, an API corresponding to one or more external systems, or an API interfacing with any application capable of assisting in resolving an issue being addressed by the CRM application.

According to some embodiments, information received by the CRM application in response to a manual step may be provided to an external application through an API in an automated step. For example, a manual steps may request the customer care agent to input a phone number, and the input phone number may be sent to an external application that can check a status of an account associated with the phone number.

In operation 450, the user device 210 may provide information obtained through an API to the CRM application. Information associated with the issue, that is obtained from an external application through an API, may be provided to the CRM application. The CRM application may autonomously process the received information as an autonomous operation of the automated step.

In operation 460, the user device 210 may execute a function on an external application via an API integrated with the playbook. For example, an automated step of the playbook may reset an adapter on a phone that is experiencing an issue. The automated step may send a phone number received from a previous manual step and a reset request to an external application that controls the network on which the phone operates. In response, the external application may send a reset signal to the phone associated with input phone number to reset the adapter.

The above operations are not limited to any particular order. The order of the operation may be dictated by a playbook being executed. For example, a customer care agent may progress through the steps of a playbook based on the feedback received from completed steps. That is, based on the feedback provided in one or more previous steps, the CRM application may proceed to one of multiple possible next steps. Once the issue is resolved, the playbook may be closed and a ticket may be generated that describes the issue, the result of the process, how the issue was resolved, and the like.

As described above, embodiments provide a knowledge management system for seamlessly resolving issues using a single application by utilizing a database of playbooks integrated with APIs that communicate with external applications. As such, the knowledge management system provides for quickly resolving issues by minimizing clicks through integrating many functions into a single application. Efficiency of resolving issues is therefore improved over related art knowledge management systems and methods.

The foregoing disclosure provides illustration and description, but is not intended to be exhaustive or to limit the implementations to the precise form disclosed. Modifications and variations are possible in light of the above disclosure or may be acquired from practice of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method comprising:
receiving, by a device and from a customer relationship management (CRM) application, information associated with a customer input;
determining, by the device, a playbook, from among a plurality of playbooks, based on the information associated with the customer input, wherein the playbook is a set of predefined steps to perform to resolve an issue;
executing, by the device, the playbook based on determining the playbook;
obtaining, by the device and via a plurality of application programming interfaces (APIs) integrated with the playbook, information associated with the issue, based on executing the playbook;
providing, by the device and to the CRM application, the information associated with the issue, based on obtaining the information associated with the issue via the plurality of APIs; and
executing, by the device and via the plurality of APIs integrated with the playbook, functions on one or more applications for resolving the issue.

2. The method of claim 1, wherein the plurality of APIs include a ticket API, a CRM API, and an API corresponding to the one or more applications.

3. The method of claim 1, further comprising:
determining, by the device, a plurality of similarity scores between the plurality of playbooks and the information associated with the customer input; and
determining, by the device, a highest similarity score from among the plurality of similarity scores,
wherein the determining, by the device, the playbook comprises determining, by the device, the playbook based on a playbook having the highest similarity score.

4. The method of claim 1, further comprising:
determining, by the device, a plurality of similarity scores between the plurality of playbooks and the information associated with the customer input; and
determining, by the device, a similarity score from among the plurality of similarity scores that satisfies a threshold, and
wherein the determining, by the device, the playbook comprises determining, by the device, the playbook based on a playbook having the similarity score that satisfies the threshold.

5. The method of claim 1, wherein the set of predefined steps includes a set of automated steps and a set of manual steps, and
wherein the obtaining, by the device and via the plurality of APIs, the information associated with the issue comprises obtaining, by the device and via the plurality of APIs, the information associated with the issue based on one or more of the automated steps.

6. The method of claim 5, further comprising:
receiving, by the device and from the CRM application, information that is responsive to a manual step of the playbook; and
obtaining, by the device and via an API of the plurality of APIs, additional information associated with the issue based on the information that is responsive to the manual step.

7. The method of claim 1, wherein the playbook comprises customizable and pre-configurable information associated with the set of predefined steps, expected results, and a set of additional steps.

8. A device comprising:
a memory configured to store instructions; and
a processor configured to execute the instructions to:
receive, from a customer relationship management (CRM) application, information associated with a customer input;
determine a playbook, from among a plurality of playbooks, based on the information associated with the customer input, wherein the playbook is a set of predefined steps to perform to resolve an issue;
execute the playbook based on determining the playbook;
obtain, via a plurality of application programming interfaces (APIs) integrated with the playbook, information associated with the issue, based on executing the playbook;
provide, to the CRM application, the information associated with the issue, based on obtaining the information associated with the issue via the plurality of APIs; and
execute, via the plurality of APIs integrated with the playbook, functions on one or more applications for resolving the issue.

9. The device of claim 8, wherein the plurality of APIs include a ticket API, a CRM API, and an API corresponding to the one or more applications.

10. The device of claim 8, wherein the processor is further configured to:
determine a plurality of similarity scores between the plurality of playbooks and the information associated with the customer input; and
determine a highest similarity score from among the plurality of similarity scores,
wherein the playbook is determined based on a playbook having the highest similarity score.

11. The device of claim 8, wherein the processor is further configured to:
determine a plurality of similarity scores between the plurality of playbooks and the information associated with the customer input; and
determine a similarity score from among the plurality of similarity scores that satisfies a threshold,
wherein the playbook is determined based on a playbook having the similarity score that satisfies the threshold.

12. The device of claim 8, wherein the set of predefined steps includes a set of automated steps and a set of manual steps, and
wherein the processor is further configured to obtain, via the plurality of APIs, the information associated with the issue based on one or more of the automated steps.

13. The device of claim 12, wherein the processor is further configured to:
receive information that is responsive to a manual step of the playbook; and
obtain, via an API of the plurality of APIs, additional information associated with the issue based on the information that is responsive to the manual step.

14. The device of claim 8, wherein the playbook comprises customizable and pre-configurable information associated with the set of predefined steps, expected results, and a set of additional steps.

15. A non-transitory computer-readable medium storing instructions, the instructions comprising: one or more instructions that, when executed by one or more processors of a device, cause the one or more processors to:
receive, from a customer relationship management (CRM) application, information associated with a customer input;
determine a playbook, from among a plurality of playbooks, based on the information associated with the customer input, wherein the playbook is a set of predefined steps to perform to resolve an issue;
execute the playbook based on determining the playbook;
obtain, via a plurality of application programming interfaces (APIs) integrated with the playbook, information associated with the issue, based on executing the playbook;
provide, to the CRM application, the information associated with the issue, based on obtaining the information associated with the issue via the plurality of APIs; and
execute, via the plurality of APIs integrated with the playbook, functions on one or more applications for resolving the issue.

16. The non-transitory computer-readable medium of claim 15, wherein the plurality of APIs include a ticket API, a CRM API, and an API corresponding to the one or more applications.

17. The non-transitory computer-readable medium of claim 15, wherein the instructions further cause the one or more processors to:
determine a plurality of similarity scores between the plurality of playbooks and the information associated with the customer input; and
determine a highest similarity score from among the plurality of similarity scores, and
wherein the playbook is determined based on a playbook having the highest similarity score.

18. The non-transitory computer-readable medium of claim 15, wherein the instructions further cause the one or more processors to:
determine a plurality of similarity scores between the plurality of playbooks and the information associated with the customer input; and
determine a similarity score from among the plurality of similarity scores that satisfies a threshold,
wherein the playbook is determined based on a playbook having the similarity score that satisfies the threshold.

19. The non-transitory computer-readable medium of claim 15, wherein the set of predefined steps includes a set of automated steps and a set of manual steps, and
wherein the instructions further cause the one or more processors to obtain, via the plurality of APIs, the information associated with the issue based on one or more of the automated steps.

20. The non-transitory computer-readable medium of claim 19, wherein the instructions further cause the one or more processors to:
receive information that is responsive to a manual step of the playbook; and
obtain, via an API of the plurality of APIs, additional information associated with the issue based on the information that is responsive to the manual step.
